(19) United States
(12) Patent Application Publication
(10) Pub. No.: US 2006/0056820 A1
(43) Pub. Date: Mar. 16, 2006

(54) Optical disc recording apparatus and method, and data recording media

(75) Inventors: Chan-lung Wu, Hsinchu (TW); Chao-ping Lin, Hsinchu (TW)

Correspondence Address: PAI PATENT & TRADEMARK LAW FIRM, 1001 FOURTH AVENUE, SUITE 3200, SEATTLE, WA, 98154, US

(73) Assignee: Newsoft Technology Corporation

(21) Appl. No.: 11/083,003

(22) Filed: Mar. 17, 2005

(30) Foreign Application Priority Data
Sep. 13, 2004 (TW) 93127653

(51) Int. Cl. H04N 5/781

(52) U.S. Cl. 386/126

(57) ABSTRACT

An optical disc recording apparatus includes an information receiving module, a commercial detecting module, an information processing module, a play parameter generating module and a write-in module. The commercial detecting module detects the start and end points of each commercial section in the real-time information received, and the information processing module transforms the real-time information into a data structure conforming to a standard recording format, meanwhile creating control information according to the recording format. The data structure includes a plurality of sublevels, and the identification number of each sublevel is adjusted according to the start and end points of each commercial section so that the start and end points of one commercial section are exactly the start and end points of one sublevel. The play parameter generating module generates play parameters conforming to the standard recording format.

### BACKGROUND OF THE INVENTION

a. Field of the Invention

The invention is related to an optical disc recording apparatus and method and, more particularly, to an optical disc recording apparatus and method that is able to generate both a play-all mode and a commercial-free mode after recording.

b. Description of the Related Art

After recording is complete, users may not want to watch the commercials that are incorporated in a recorded program when the recorded program is playing. There are numerous methods proposed in patents to meet the aforesaid requirement, where some of them concern the editing and deletion of the commercials after recording, and some of them concern the detection and deletion of the commercials during recording.

For example, U.S. Pat. No. 5,987,210 and U.S. Pat. No. 4,752,834 disclose videocassette recorders (VCR) that may automatically detect and edit commercials. The design is to automatically detect breaks that appear at the start and the end of one commercial section; when a break appearing at the start of the commercial section is detected, a timing circuit is activated, and meanwhile the recording is paused to prevent the commercial from being recorded onto the magnetic strip. Then, when a preset commercial time (for example, 30 seconds or 1 minute) for the timing circuit is up, the recording device automatically returns to recording if the timing circuit does not receive other signals requesting stopping or re-timing.

However, the disadvantages of this design are as follows: Because time-delay occurs during the switch of the recording device from a pause mode to a record mode, and because the commercial section is often shorter than the preset time, part of the program that commences subsequently after the commercial section may not be recorded, thus causing unrecoverable loss of partial program content.

Moreover, in recent years, some DVD recorder/player systems (such as Pioneer DVR7000) have a commercial skip button (CM skip button) on remote controls so that an user can stop recording for 30 seconds (the longest pause time can be up to 4 minutes) to prevent commercials from being recorded onto the DVD disc. However, the user may fail to press the CM skip button in time, which causes unrecoverable loss of partial program content.

### SUMMARY OF THE INVENTION

An object of the invention is to provide an optical disc recording apparatus and method, which allows for generating two reproduction ways including a play-all mode and a commercial-free mode for a recorded program to avoid unrecoverable loss of program content.

According to the invention, an optical disc recording apparatus includes an information receiving module, a commercial detecting module, an information processing module, a play parameter generating module and a write-in module. The information receiving module is used to receive real-time information, and the commercial detecting module detects the start and end points of each commercial section in real-time information. The information processing module transforms the real-time information into a data structure conforming to a standard recording format, meanwhile creating control information according to the recording format. The data structure includes a plurality of sublevels, and the identification number of each sublevel is adjusted according to the start and end points of each commercial section so that the start and end points of one commercial section are exactly the start and end points of one sublevel. The play parameter generating module generates play parameters conforming to the standard recording format, and the write-in module stores the data structure, the control information, and the play parameters in a recording media.

Through the design of the invention, two different reproduction modes are generated according to two different program chains formed from the identification number of each sublevel. Hence, the play-all mode and commercial-free mode both exist to avoid unrecoverable loss of program content during recording. Also, when playing the recorded optical disc, one can select both the commercial-free mode to auto skip the commercial contents or the play-all mode to play the entire recorded content.

### BRIEF DESCRIPTION OF THE DRAWINGS

FIG. 1 is a block diagram illustrating an optical disc recording apparatus according to an embodiment of the invention.

FIG. 2 illustrates a file structure of a standard recording format of DVD-Video.

FIG. 3 is a schematic diagram illustrating the relationship between video object set, video objects, cells, and video object units.

FIG. 4 is a schematic diagram illustrating program chains that control reproduction sequences of a standard recording format when the real-time information is playing.

FIG. 5 illustrates a schematic diagram of an information receiving module according to the invention.

FIG. 6 is a schematic diagram illustrating a design for generating both a play-all mode and a commercial-free mode in accordance with the invention.

FIG. 7 is a schematic diagram illustrating a menu having a play-all mode button and a commercial-free mode button.

FIG. 8 illustrates a schematic diagram of a write-in module.

FIG. 9 is a flow chart illustrating the steps of an optical disc recording method according to the invention.

### DETAILED DESCRIPTION OF THE INVENTION

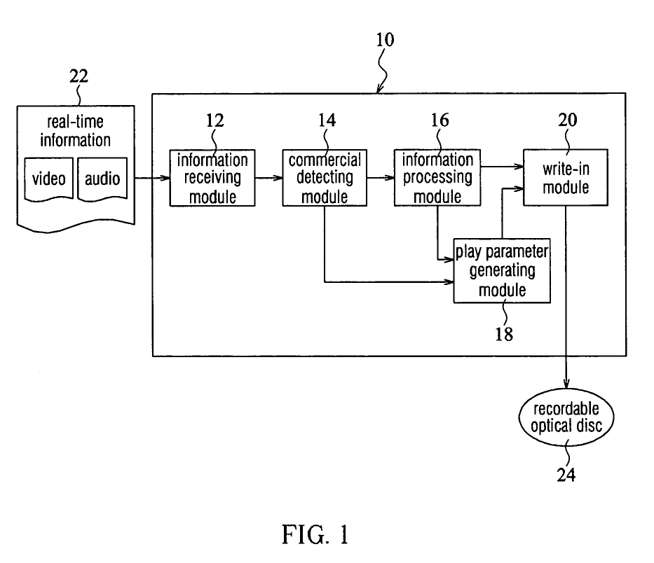

Referring to FIG. 1, an optical recording apparatus 10 according to an embodiment of the invention includes an information receiving module 12, a commercial detecting module 14, an information processing module 16, a play parameter generating module 18, and a write-in module 20. The optical recording apparatus 10 stores video or audio data onto a recordable optical disc 24. The recordable optical disc 24 may be a write-once optical disc or a re-writable/re-recordable optical disc.

The relationship between a standard recording format and the invention is first described. Typically, the recording formats for optical disc application include: DVD video recording format, DVD-Video format, DVD+RW video format, high definition DVD Video format, large capacity blu-ray disc recording format, enhanced versatile disc (EVD) format, and forward versatile disc (FVD) format. The DVD-Video format is described below in detail as an example of the recording formats.

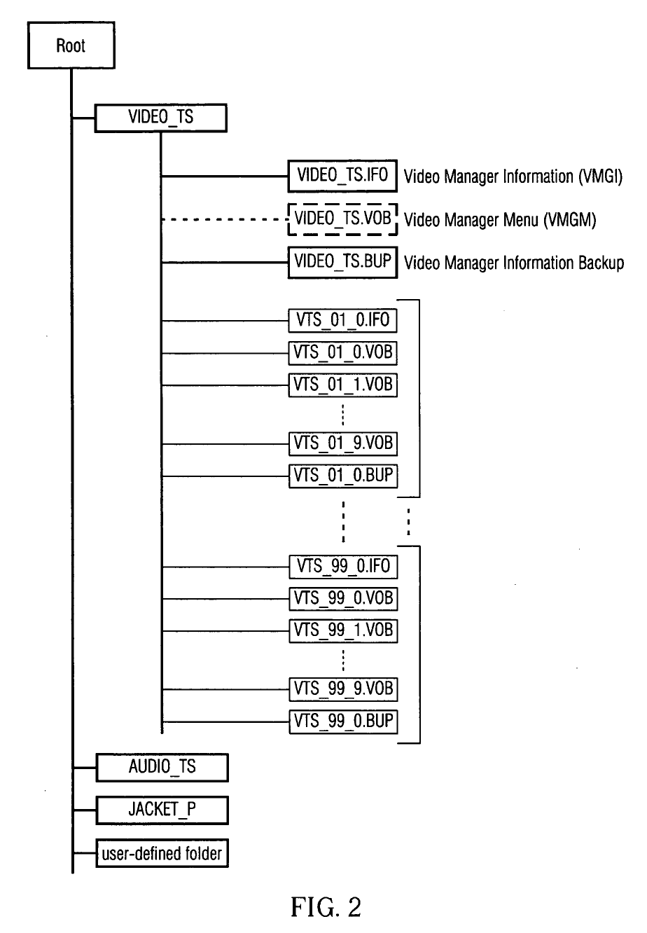

FIG. 2 illustrates a file structure of the DVD-Video format. As shown in FIG. 2, a video manager (VMG) that provides managing information of the entire program contents includes a video manager information (VMGI) which stores control information, a video object set (VOBS) which stores video manager menu (VMGM) as data for menu display, and backup video manager information (VMGI backup) which additionally stores content identical to the VMGI. The structures described above correspond to three separate files: VIDEO_TS.IFO, VIDEO_TS.VOB, and VIDEO_TS.BUP.

The video manager group (VMG) may optionally include a main menu for an optical disc, and the main menu may be a list of the disc contents. If the main menu exists, it is often the first scene that is seen by users when the disc is playing.

The real content of the program is stored in video title sets (VTS); a disc may have 99 video title sets (VTS) at most. On the disc, each VTS may have up to 10 video object (VOB) files, and each VOB file can store a large section of data blocks.

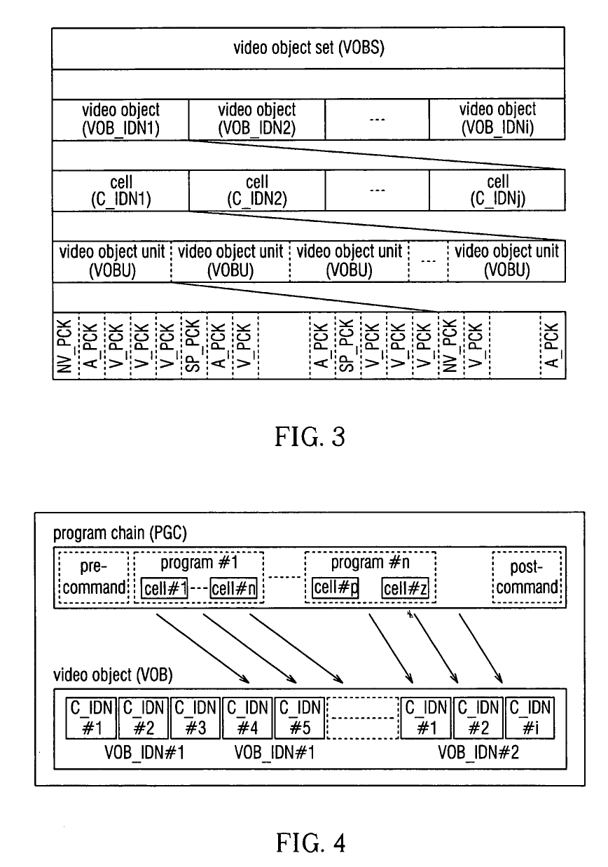

Referring to FIG. 3, the video object set (VOBS) is made up of one or several video objects (VOB_IDN₁, VOB_IDN₂, . . . , VOB-IDNᵢ), and each VOB is for storing real-time video/audio information and is made up of smaller cells (C_IDN₁, C_IDN₂, . . . , C_IDNⱼ). The numbers shown on the figure are cell identifications (cell ID) illustrating the relative position of each cell in the VOB. Thus, a cell can be specified by identifying both its cell ID and the ID of the video object that includes the cell.

Further, each cell is made up of multiple video object units (VOBU), and each video object unit (VOBU) is made up of different types of packs, such as navigation packs (NV_PCK), video packs (V_PCK), subpicture packs (SP_PCK) and audio packs (A_PCK).

The navigation pack (NV_PCK) is the control information used for reproduction, replaying, or searching the real-time information stored in the VOBU. The video pack (V_PCK) is stored video information, and the audio pack (A_PCK) is stored sound information.

Hence, the real-time information must be transformed into the data structure conforming to a standard recording format during disc recording, and meanwhile control information conforming to that recording format is generated. The control information, for example, can be the information stored in the video manager (VMG) or in the navigation packs (NV_PCK) stored in aforesaid data structures.

FIG. 4 is a schematic diagram illustrating how program chains (PGC) control the reproduction sequences in a standard recording format when the real-time information is playing. A DVD-Video disc may have a plurality of program chains (PGC) for producing multiple reproduction sequences. The user may select one of the program chains (PGC) to produce the corresponding reproduction sequence. As shown in FIG. 4, the program chain (PGC) comprises a plurality of programs, from program# 1 to program #n, and each program includes pointer information for the cells. The pointer information is defined by the cell ID and the video object ID. The program chain (PGC), recorded on the management information recording area of the optical disk, is read prior to the reading of the video title set and then stored in the memory of the system controller.

The design of each module of the optical disc recording apparatus 10 according to the invention is described in the following.

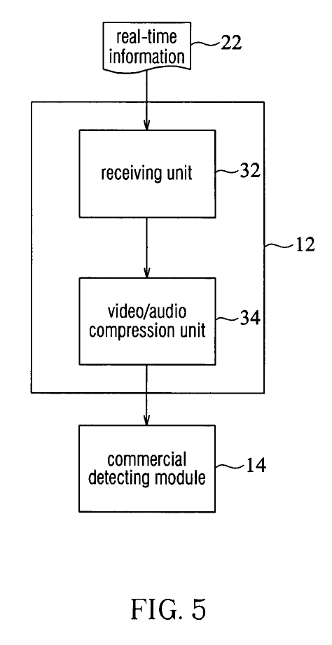

Referring to FIG. 5, an information receiving module 12 includes a receiving unit 32 and a video/audio compression unit 34. The receiving unit 32 receives real-time information 22, which may be video/audio information or signals from wired or wireless television broadcasting, video/audio information or signals from digital or analog television broadcasting, or video/audio information or signals from a digital or analog camcorder or recorder. The receiving unit 32 may be a TV turner card, video capture card, or digital TV receiver that can be arbitrarily selected to match the type of the real-time information 22.

After being received by the receiving unit 32, the real-time information 22 is first processed by video and audio transformations separately and then fed into the video/audio compression unit 34, in which the real-time information is compressed and encoded according to a compression format conforming to the standard recording format during recording. The encoding/compression format includes, but is not limited to, MPEG-1, MPEG-2, MPEG-4, H.264, WMV or VC-9 (VC-1).

The aforesaid video/audio compressing and encoding process of the real-time information can be done by a hardware encoder or a software encoder.

Referring to FIG. 1, after the real-time information is received by the information receiving module 12, the commercial detecting module 14 detects the start and the end points of each commercial section in the real-time information, and then the information processing module 16 processes the real-time information according to a selected recording format during recording.

In regard to the commercial detecting module 14 of the invention, the method of detecting the start and end points of each commercial section is not limited. For example, one may detect the breaks that appear subsequently before the start and after the end of one commercial section, or inserted black frames or blank frames. Alternatively, the technologies such as video/audio content analysis or scene detection may be used. Conventional commercial detection technologies are sufficient to detect the start and end points of each commercial section effectively. Take the black frames detection as an example, where the black frames are often inserted subsequently before and after one commercial section in television programs, an inputted frame is considered to be a black frame if the difference between the luminance of the inputted frame and the average black frame luminance is within a limit such as 5%.

The operation of the commercial detecting module 14 of the invention is not limited to the aforesaid active detecting methods of conventional technology, the commercial detecting module 14 can also detect the start and end points of commercial sections manually set by the user using input devices such as a remote control.

Once the commercial detecting module 14 detects the start point or the end point of each commercial section in real-time information 22, the information is transmitted to the information processing module 16. Throughout the specification and the claims, the definition of “one commercial section” is the duration of the commercial content between two adjacent program contents.

The information processing module 16 arranges the inputted real-time information 22 according to a standard recording format (such as the DVD-Video standard shown in FIG. 2). The encoded real-time information is arranged sequentially from the smallest unit to the largest one: the pack, VOBU, cell, VOB, and VOBS. Meanwhile, the information processing module 16 generates control information which is stored in the aforesaid data structures such as the VMG and NV_PCK. The control information is used for controlling the reproduction of the real-time information, e.g. providing the user with control functions such as quick search for the program contents.

The invention is designed to incorporate the information of the start and end points of commercial sections transmitted from the commercial detecting module 14 into the process of transforming the real-time information to a data structure conforming to a standard recording format.

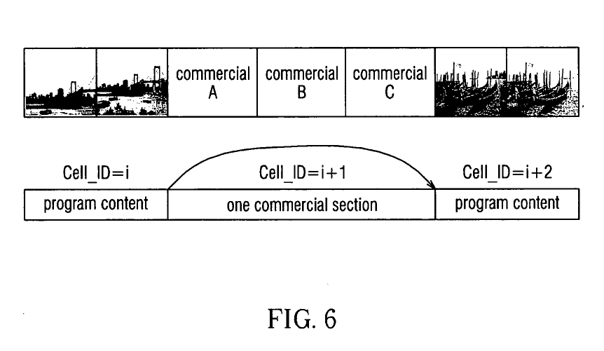

Referring to FIG. 6, according to the design of the invention, once the commercial detecting module 14 detects a start point of a commercial section in the real-time information, the information processing module 16 is notified immediately and, according to the standard recording format, assigns a new cell ID (Cell_ID=i+1) to the subsequent commercial section (including commercials A, B, and C) during recording. When the commercial detecting module 14 detects the end point of the commercial section, it notifies the information processing module 16 to assign a serial new cell ID (Cell_ID=i+2) to the subsequent program content during recording in accordance with the standard recording format. Thus, through this design, after the information processing module is notified the start and end points of the commercial section, an independent ID number is assigned to an individual commercial section (Cell_ID=i+1, shown in FIG. 6). That is, the commercial section is separated from the program contents which precede and follow it (Cell_ID=i, Cell_ID=i+2) with regard to the assignment of ID number. In other words, the information processing module 16 adjusts the ID numbers of sublevels (e.g. cells) of the data structure basing on the start and end points of each commercial section so that the start and end points of one commercial section are the start and end points of one sublevel such as one cell.

Then, the play parameter generating module 18 creates various program chains (PGC) as play parameters for generating various reproduction sequences according to the standard recording format and aforesaid design method. For example, in this invention the program chain (PGC) can be created as:
a) play-all cells, namely including cells with Cell_ID=i, Cell_ID=i+1, Cell_ID=i+2, Cell_ID=i+3 . . . etc, generating a play-all reproduction sequence of the entire program content including commercials; or
b) commercial-free cells, namely including cells with Cell_ID=i, Cell_ID=i+2, . . . etc, generating a commercial-free reproduction sequence of the program content without commercials by precluding the cells of the commercial section (such as the cell with Cell_ID=i+1) into the program chain (PGC).

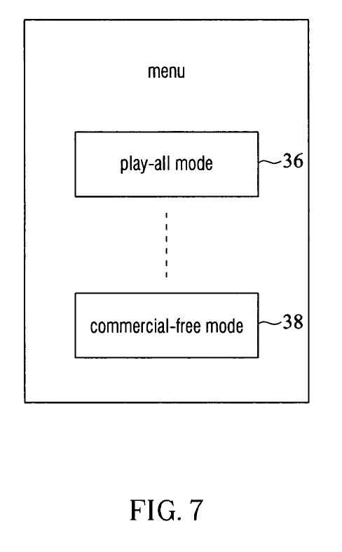

After the recording is complete, the navigation information regarding two different reproduction modes are generated according to the above two different program chains and the standard recording format. The navigation information may be the menu of a DVD-Video format shown in FIG. 7. When a user pushes the play-all mode button 36 on the menu, the program chain containing the play-all sequence is activated to play the entire original recorded content; while the user pushes the commercial-free mode button 38 on the menu, the program chain containing the commercial-free sequence is activated to play the program content without commercials (play cells that are not commercials). Moreover, in other standard recording format such as DVD-VR, the navigation information corresponding to different play modes may be displayed in different play lists, which can be activated through the selection from users.

Therefore, through the design of the invention, the play-all mode and commercial-free mode both exist to avoid the unrecoverable loss of the program content during recording. Also, when playing the recorded optical disc, one can select both the commercial-free mode to auto skip the commercial contents or the play-all mode to play the entire recorded content.

It should be noted that the sublevels of the data structure includes, but is not limited to, the cells. The invention only requires that an independent ID number is assigned to an individual commercial section, and the play parameter is generated according to the serial ID numbers. There is no limitation on which sublevel of which standard recording format is to be selected.

Further, because one VOB may have 1 to 255 cells that are sufficient for general recordings, only one video object identification (VOB ID) is exemplified in the invention (all cell IDs belong to the same video object ID; VOB_ID=1). However, the invention may also combine more than one video object identification, i.e., the cell IDs may belong to different VOB IDs if required.

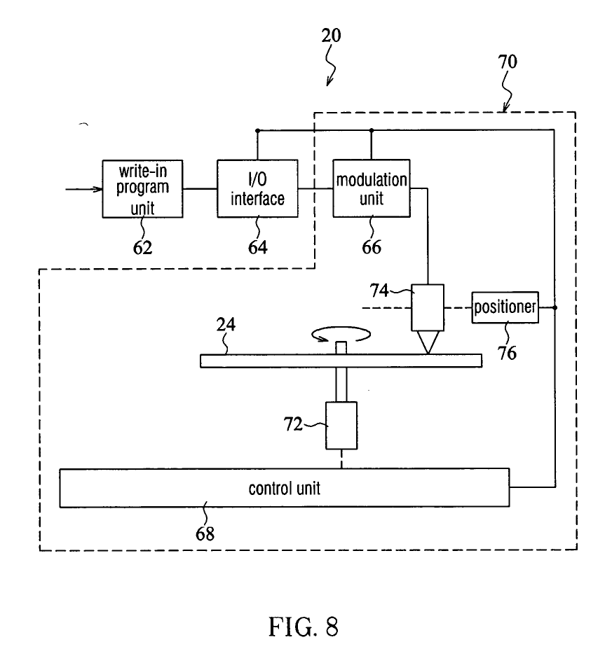

Referring to FIG. 8, a write-in module 20 includes a write-in program unit 62, an input/output (I/O) interface 64, and a disc recorder 70. The write-in program unit 62 drives the I/O interface 64 via programs to record the data structure, navigation information, and play parameters that are generated by the information processing module 16 and the play parameter generating module 18 onto a recordable optical disc 24.

The I/O interface 64 is responsible for giving the information to be recorded and the commands of driving the disc recorder 70 given by the write-in program unit 62 to the disc recorder 70 to execute the write-in operation. The disc recorder 70 includes a motor 72 for rotating the recordable optical disc 24, a head 74 for reading, writing, or scanning the track of the recordable optical disc 24, and a positioner 76 for initially positioning the head 74 in a radial direction. The disc recorder 70 further includes a modulation unit 66 and a control unit 68. The control unit 68 controls related devices of the disc recorder 70 such as the motor 72 and the positioner 76 via a control line such as a system bus. The control unit 68 can be made of a control circuit such as a microprocessor, program memory, or control gates. The data structure, navigation information, and play parameters generated by the information processing module 16 and the play parameter generating module 18 are transformed into write signals via the write-in module 20 to drive the head 74, so that the information is written onto the recordable optical disc 24 for storage.

Though the invention is exemplified as using the write-in module 20 to record the data structure, the navigation information, and the play parameters onto a recordable optical disc 24, the optical disc recording method of the invention is not limited to the above. The media for recording the data structure conforming to a standard recording format, the control information and play parameters is not limited to a recordable optical disc; for example, they also can be stored directly on a computer readable recording media such as a hard disk and a memory card.

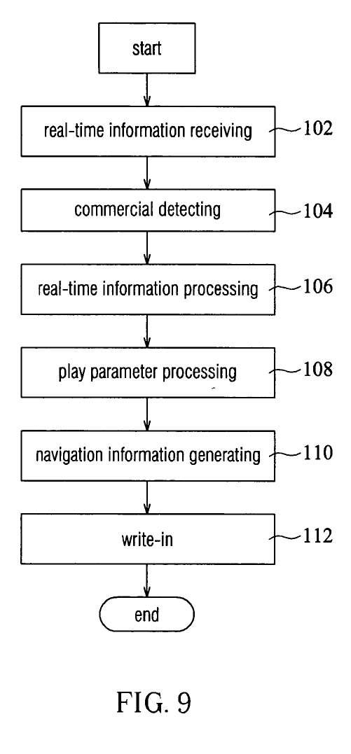

FIG. 9 is a flow chart illustrating the steps of an optical disc recording method, in which the method proceeds according to the invention.

When recording begins, real-time information receiving step 102 is initiated. The real-time information receiving step 102 includes the operation of compressing and encoding video/audio, in which the real-time information is encoded according to a compression format of the selected recording format during recording, such as MPEG-2.

Then, in the commercial detecting step 104, the start and end points of each commercial section in the real-time information is detected, and they may be generated by a commercial detecting module that auto detects each commercial section or detects a manual set from a user.

After detecting the start and end points of each commercial section, proceed to real-time information processing step 106. The step is to assign an independent ID number to each individual commercial section. That is, the commercial section is separated from the program contents which precede and follow it (Cell_ID=i, Cell_ID=i+2) with regard to the assignment of ID number. In other words, the information processing module 16 adjusts the ID numbers of sublevels (e.g. cells) of the data structure basing on the start and end points of each commercial section so that the start and end points of one commercial section are the start and end points of one sublevel such as one cell. The cell mentioned herein is a sublevel of the data structure of DVD-Video format and is only for illustration purposes. There is no restriction as to which standard recording format to be used and which sublevel to be incorporated into the same commercial section.

Moreover, the real-time information processing step 106 is responsible for generating the control information conforming to the standard recording format at the same time. The control information is used for controlling the reproduction of the real-time information, e.g. providing the user with control functions such as quick search for the program contents.

Then, proceed to play parameter processing step 108, by which the program chains are generated as play parameters for generating various reproduction sequences. The program chains include cell identification numbers of the play-all mode for generating a reproduction sequence of the entire program content, and cell identification numbers of the commercial-free mode for generating a reproduction sequence of the program without commercial content.

After the generation of the play parameters, proceed to navigation information generating step 110. Basing on the two different program chains, navigation information for different play modes are generated according to the standard recording format adopted during recording. One selection of the navigation information activates the play-all program chain serving as the play mode or reproduction sequence to play the entire content of the original recording; the other selection activates the commercial-free program chain serving as the play mode or reproduction sequence to play the program content without commercials.

Finally, in write-in step 112, the data structure, control information, and navigation information corresponding to play-all and commercial-free modes, which all conform to the standard recording format, are written onto a computer-readable recording media. The recording media may be a recordable optical disk, a hard disk, or a memory card.

While the invention has been described by way of example and in terms of the preferred embodiment, it is to be understood that the invention is not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. An optical disc recording apparatus, comprising:
an information receiving module for receiving real-time information;
a commercial detecting module for detecting the start and end points of each commercial section in the real-time information;
an information processing module for transforming the real-time information into a data structure conforming to a standard recording format, and meanwhile creating control information according to the standard recording format, wherein the data structure includes a plurality of sublevels, and the identification number of each sublevel is adjusted according to the start and end points of each commercial section so that the start and end points of one commercial section are exactly the start and end points of one sublevel;
a play parameter generating module for generating play parameters conforming to the standard recording format; and
a write-in module for storing the data structure, the control information, and the play parameters in a recording media.

2. The optical disc recording apparatus according to claim 1, wherein the information processing module increments the identification number of the sublevel by one at each encounter with the start point and the end point of every commercial section when adjusting the identification number of the sublevel of the data structure.

3. The optical disc recording apparatus according to claim 1, wherein the play parameters include a first program chain corresponding to a play-all mode and a second program chain corresponding to a commercial-free mode, and the program chains comprise pointer information including the sublevel identification number and the identification number of an upper level of the sublevel.

4. The optical disc recording apparatus according to claim 3, wherein the sublevel is a cell of the data structure, and the upper level is a video object of the data structure.

5. The optical disc recording apparatus according to claim 1, wherein the standard recording format is DVD video recording format, DVD-Video format, DVD+RW video format, high definition DVD video format, large capacity blu-ray disc recording format, enhanced versatile disc format, or forward versatile disc format.

6. The optical disc recording apparatus according to claim 1, wherein the real-time information comprises at least one of video, audio, signal for video and signal for audio, and the source of the real-time information is selected from the group consisting of wired television broadcast, wireless television broadcast, digital television broadcast, analog television broadcast, recorded content from a digital recording device, and recorded content from an analog recording device.

7. The optical disc recording apparatus according to claim 1, wherein the information receiving module comprises a receiving unit and a video/audio compression unit.

8. The optical disc recording apparatus according to claim 7, wherein the video/audio compression unit is a hardware encoder or a software encoder, and the video/audio compression unit compresses the real-time information according to a compression format selected from the group consisting of MPEG-1, MPEG-2, MPEG-4, H.264, WMV, and VC-9 (VC1).

9. The optical disc recording apparatus according to claim 1, wherein the write-in module is an optical disc writer, and the recording media is a write once optical disc or a re-writable/re-recordable optical disc.

10. The optical disc recording apparatus according to claim 1, wherein the recording media is a hard disk or a memory card.

11. The optical disc recording apparatus according to claim 1, wherein the play parameter generating module further generates navigation information corresponding to each play parameter.

12. The optical disc recording apparatus according to claim 11, wherein the play parameter is activated via a menu button or a play list in the navigation information.

13. The optical disc recording apparatus according to claim 1, wherein the start and end points of each commercial section are generated by the commercial detecting module that auto detects each commercial section or detects a manual set from a user.

14. An optical disc recording method, comprising the steps of:
receiving real-time information;
detecting the start and end points of each commercial section in the real-time information;
transforming the real-time information into a data structure conforming to a standard recording format, wherein the data structure includes a plurality of sublevels, and meanwhile adjusting the identification number of each sublevel of the data structure according to the start and end points of each commercial section such that the start and end points of one commercial section are exactly the start and end points of one sublevel;
creating control information conforming to the standard recording format for controlling the reproduction of the real-time information;
generating play parameters according to the identification numbers; and
storing the data structure, the control information, and the play parameters in a recording media.

15. The optical disc recording method according to claim 14, wherein the real-time information receiving step includes a video/audio compression operation for compressing the real-time information according to a compression format selected from the group consisting of MPEG-1, MPEG-2, MPEG-4, H.264, WMV, and VC-9 (VC-1).

16. The optical disc recording method according to claim 14, further comprising the step of generating navigation information corresponding to the play parameters.

17. The optical disc recording method according to claim 16, wherein the play parameter is activated via a menu button or a play list in the navigation information.

18. The optical disc recording method according to claim 14, wherein the start and end points of each commercial section are detected by a commercial detecting module that auto detects each commercial section or detects a manual set from a user.

19. The optical disc recording method according to claim 14, wherein the identification number of the sublevel is adjusted by incrementing the identification number by one at each encounter with the start point and the end point of every commercial section.

20. The optical disc recording method according to claim 14, wherein the play parameters include a first program chain corresponding to a play-all mode and a second program chain corresponding to a commercial-free mode, and the program chains comprise pointer information including the sublevel identification number and the identification number of an upper level of the sublevel.

21. The optical disc recording method according to claim 20, wherein all the identification numbers of the sublevel are associated with the identification number of the upper level of the sublevel.

22. The optical disc recording method according to claim 20, wherein the sublevel is a cell of the data structure, and the upper level is a video object of the data structure.

23. The optical disc recording method according to claim 14, wherein the standard recording format is DVD video recording format, DVD-Video format, DVD+RW video format, high definition DVD video format, large capacity blu-ray disc recording format, enhanced versatile disc format, or forward versatile disc format.

24. The optical disc recording method according to claim 14, wherein the real-time information comprises at least one of video, audio, signal for video and signal for audio, and the source of the real-time information is selected from the group consisting of wired television broadcast, wireless television broadcast, digital television broadcast, analog television broadcast, recorded content from a digital recording device, and recorded content from an analog recording device.

25. The optical disc recording method according to claim 14, wherein the recording media is a recordable optical disc, a hard disk, or a memory card.

26. A computer readable recording media having a data structure, which includes a plurality of sublevels, control information, and play parameters stored thereon, and all of them conforming to a standard recording format, wherein:
the identification numbers of the sublevels of the data structure on the recording media are adjusted according to the start and end points of each commercial section in received real-time information, so that the start and end points of one commercial section are exactly the start and end points of one sublevel, and the play parameters are generated according to the adjusted identification numbers.

27. The recording media according to claim 26, further having navigation information thereon in correspondence to the play parameters.

28. The recording media according to claim 26, wherein the play parameters include a first program chain corresponding to a play-all mode and a second program chain corresponding to a commercial-free mode.

29. The recording media according to claim 26, wherein the recording media is a recordable optical disc, a hard disk, or a memory card.
